(19) United States
(12) Patent Application Publication
(10) Pub. No.: US 2024/0199401 A1
(43) Pub. Date: Jun. 20, 2024

(54) CONTAINER TREATMENT SYSTEM AND CONTAINER TREATMENT METHOD FOR TREATING CONTAINERS

(71) Applicant: KRONES AG, Neutraubling (DE)

(72) Inventor: Frank Winzinger, Neutraubling (DE)

(73) Assignee: Frank Winzinger, Neutraubling (DE)

(21) Appl. No.: 18/556,535

(22) PCT Filed: Mar. 3, 2022
(86) PCT No.: PCT/EP2022/055426

§ 371 Date: Oct. 20, 2023

(30) Foreign Application Priority Data
Apr. 20, 2021 (DE) 10 2021 110 009.7

(51) Int. Cl. B67C 3/00; B65C 9/40; B67B 3/26

(52) U.S. Cl. CPC B67C 3/007; B65C 9/40; B67B 3/26

(57) ABSTRACT

A container treatment system (1; 1A; 1B) and a container treatment method for treating containers (2; 2A) are provided. The container treatment system (1; 1A; 1B) has at least two container treatment devices (10; 14; 15; 20; 30; 40; 50; 60; 69; 70; 80; 90; 110; 120; 130; 140) for treating a container (2; 2A) by at least one of the following types of treatment, namely transporting, buffering, sorting, grouping, inspecting, heating, forming, equipping, coating, sterilizing, filling, sealing, cleaning, packaging, palletizing, depalletizing, a detection apparatus (4; 5) for detecting at least one operating state of the at least two container treatment devices (10; 14; 15; 20; 30; 40; 50; 60; 69; 70; 80; 90; 110; 120; 130; 140), and an evaluation apparatus (4A; 5A) which is designed to evaluate the detection result of the detection apparatus (4; 5) with respect to the type of operating state detected.

The present invention relates to a container treatment system and a container treatment method for treating containers.

Container treatment systems are used for industrial production of containers and/or for filling a product into containers and/or for labeling containers and/or for packaging containers. Containers are in particular cans, glass bottles, paper bottles, plastic bottles or similar. The product is, for example, a beverage, a cleaning means, a cosmetic product, a piece goods, etc. The container treatment system may be or comprise, for example, a forming device, a cleaning device, a filling device, a closing device, an inspection device, a transport device, an equipment device, a packaging device, etc.

In such a container treatment system, often at least two of said devices are arranged one after the other so that containers are passed from device to device for treating. In the individual devices, the containers are usually fed to the respective treating in a row in which the containers are arranged one after the other. For example, treating a container is filling it with the product or labeling it with a label. Depending on the design, a container treatment system can have a throughput in the 5-digit area per hour, in particular of up to approximately 96,000 containers per hour or more. Therefore, errors in treating the containers usually lead to undesirable and often lengthy plant shutdowns.

In order to reduce and, at best, avoid the risk of undesirable system downtimes, buffer storage is usually provided between the individual devices. In a buffer storage system, a plurality of containers are transported and/or temporarily stored next to one another and one after the other, e.g. in bulk transport. This gives more time to react to any errors in the treatment of the containers in the container treatment system. In addition, the time can be used to replenish material, such as labels, product to be deposited, cleaning means, etc., required in the system during manufacturing, if necessary, in the respective devices.

Troubleshooting, replenishing material, and converting the system to a different container type, particularly container size, or product type must usually be performed by operating personnel. In the case of a larger container treatment system, more than one person is required for this purpose in order to be able to ensure the smoothest possible operation of the container treatment system. Operating personnel require time-consuming training and are not always readily available. In addition, errors made by the operating personnel during operation of the container treatment system can cause the system to come to a standstill. The result is high costs for the system operator.

Another complicating factor is that container treatment systems usually require a large amount of space. Sometimes individual devices of the container treatment system are installed in more than one room. At least in such cases, the entire container treatment system is not fully visible to operating personnel. As a result, even operating personnel who have undergone extensive training cannot always foresee in good time or correctly which activities are to be performed next and when.

Therefore, it is an object of the present invention to provide a container treatment system and a container treatment method for treating containers, with which the aforementioned problems can be solved. In particular, a container treatment system and a container treatment method for treating containers are to be provided, with which the operation of the container treatment system can be realized cost-effectively and with a low probability of system downtimes.

This object is achieved by a container treatment system for treating containers according to the independent device claim. The container treatment system has at least two container treatment devices for treating a container by at least one of the following treatment types, namely transporting, buffering, sorting, distributing, unpacking, de-labeling, unscrewing, drying, grouping, inspecting, heating, forming, equipping, coating, sterilizing, filling, sealing, cleaning, packing, palletizing, depalletizing, a detection apparatus for detecting at least one operating state of the at least two container handling apparatuses, and an evaluation apparatus which is designed for evaluating the detection result of the detection apparatus with respect to the type of operating state detected.

A container handling device can, for example, handle containers in two or three manners, in particular simultaneously, e.g. transporting with a labeling carousel during equipping or forming the container with liquid product, i.e. forming during filling.

The at least two container handling devices may have a distance between them, preferably of at least one meter, more preferably of at least 5 m, even more preferably of at least 20 m.

The two container treatment devices can be arranged in the same system area. A system area can be formed, for example, by a wet part (where, among other things, the filler is arranged) or a dry part (where a packing machine for packing filled containers into secondary packaging or a palletizer or a glue pack making machine is arranged) or a return part (for sorting/unpacking and, if necessary, cleaning returned empties) or a warehouse (for storing loaded pallets).

The two container treatment devices can alternatively be arranged in different system areas.

System areas can be separated from one another by walls (through-openings for containers/container conveyors/persons excluded).

One of the two container treatment devices preferably performs a type of treatment on the containers that the other does not perform.

In particular, both container handling devices may each perform a type of treatment on the containers that the other does not perform.

In particular, three container handling devices may be provided, each of which performs one type of treatment with the containers and the other two do not.

With the container treatment system, an exact determination of operating states of at least two devices of the container treatment system can be carried out very reliably and in a time-saving manner. As a result, it is quicker and/or easier to determine actions to be initiated for the correct response to each detected operating state or to be performed sequentially in a predetermined order.

In particular, the container treatment system makes it possible to reliably communicate the nature of a fault to operating personnel or robots. Robots and/or replenishment units can subsequently automatically perform the activity to be performed, such as replenishing material, etc., or changing the trimmings of the devices.

In addition, it is possible to provide operating personnel in particular with specific instructions on which activities to perform more quickly and with a high degree of reliability. As a result, pending activities to correct a fault or replenish material in a container handling device can be completed in such a manner that a fault does not occur or a fault that has occurred continues to have a negative effect during processing in at least one subsequent container handling device. In addition, errors can be quickly corrected with the help of the hints.

All these measures have the advantage that the operating personnel can be guided in a targeted manner and without detours in order to carry out the activities in question in the correct sequence.

In doing so, it is possible to inform the operating personnel of the optimal route in the container treatment system for the upcoming activities.

This allows operating personnel to avoid unnecessary walking and/or activities. In addition, safety-critical situations can be avoided. As a result, operating personnel can work particularly efficiently and safely. It also allows manufacturing with the container treatment system to be optimized and run smoothly.

Overall, the described design of the container treatment system also makes the familiarization and any repeated training(s) of the operating personnel significantly less time-consuming and costly.

The container treatment system is thus designed in such a manner that the number and/or duration of undesirable system downtimes can be minimized. In addition, the container treatment system can minimize scrap. All this contributes to an optimized and ultimately very cost-effective use of resources.

Advantageous further embodiments of the container treatment system are given in the dependent patent claims.

Possibly, the evaluation apparatus is configured to evaluate which at least one activity is to be performed on at least one of the at least two container handling devices as a result of the at least one operating state detected by the detection apparatus.

In accordance with one embodiment, the evaluation apparatus is configured to determine at least one indication of the at least one activity to be performed on the at least one container treatment device based on the detected operating state and to output the at least one indication, in particular to an operator and/or a refilling aggregate of the at least one container treatment device and/or to an apparatus for storing the at least one indication for use in the future operation of the container treatment system.

In accordance with yet another embodiment, the evaluation apparatus is configured to evaluate which shortest path an operator has to cover in order to carry out the evaluated at least one activity, wherein the evaluation apparatus is configured in particular to output the evaluated shortest path for the operator.

In this case, the evaluation apparatus can be designed to determine the shortest path in relation to the container treatment system and/or the entire premises of a plant in which the container treatment system is installed.

In accordance with yet another embodiment, the evaluation apparatus is configured to evaluate which material is to be reordered at at least one of the at least two container treatment devices as a result of the at least one operating state detected by the detection apparatus. The evaluation apparatus can be designed to output information about the material to be reordered to a display apparatus for display.

Conceivably, the type of operating state detected comprises the type of fault that occurs with the container treatment device. Here, the nature of a fault may comprise whether the fault endangers the safety of an operator of the at least one container treatment device and/or how quickly the fault is to be rectified in order not to endanger the safety of the at least one container treatment device or of the operator of the at least one container treatment device, wherein the evaluation apparatus is configured in particular to evaluate in which sequence activities are to be carried out or blocked as a consequence of the at least one operating state detected by the detection apparatus on at least one of the at least two container treatment devices.

In one embodiment, the detection apparatus may have at least one camera arranged at a distance of at least 1 m, preferably at least 3 m, above (further away from the center of the earth in the vertical direction) the at least two container treatment devices of the container treatment system, if possible of the entire container treatment system.

It may be that the detection apparatus is arranged in an area between 1 m and 20 m, preferably between 3 m and 15 m, more preferably between 4 m and 10 m, above a base on which one of the two container treatment devices is located.

The detection apparatus may be configured to receive an optical signal (e.g., light) from each of the two container treatment devices. The optical signal comprises the operating state.

In particular, an optical signal may be redirected via at least one mirror and reach the detection apparatus. A mirror may be arranged at a level between the treatment device and the detection device for redirecting optical signals.

Additionally or alternatively, the detection apparatus may have the evaluation apparatus. Additionally or alternatively, the container treatment system has a control apparatus which is configured to control the at least one container treatment device and which has at least a part of the evaluation apparatus.

Optionally, the detection apparatus has at least one mirror arranged to direct an optical signal from the container treatment system to the detection apparatus.

Additionally or alternatively, the evaluation apparatus can be configured to use, for the evaluation of the detection result of the at least one detection apparatus, data of an apparatus that stores at least one indication that was determined and output in the preceding operation of the container treatment system. Additionally or alternatively, the container treatment system may be configured to receive at least one indication from an external apparatus that at least one activity is to be performed on at least one of the at least two container treatment devices.

For example, the following container treatment devices may be associated with the above container treatment types:

Buffering: accumulating conveyors for containers or packs containing containers or transporters for mass transport or dynamic buffers for buffering individual containers, FIFO buffers for containers, FILO buffers for containers, preform feed chute, in each case preferably part of the wet part

Sorting: Gripping devices for reusable containers, for example for transferring containers from or into crates, diverters for grading, preform sorters (preform hoppers), closure sorters, in the case of already filled and closed containers in each case preferably part of the wet part or in the case of empty containers in each case preferably part of the return part Grouping: Grouping devices for creating groups of containers for packaging, for example restraining dividers and/or push bars

Inspecting: Inspection apparatus of any kind, for example for inspecting wall thicknesses of PET bottles, temperatures of preforms, fill level inspection, container type detection, caustic detection inside the container, for checking the presence of containers or the number of containers passed, label fit control apparatus

Heating: oven for preforms to heat them (preferably part of the wet part or sometimes also part of a dry part, e.g. with connection to the wet part by a long air transport), oven for shrinking shrink foil onto packs (part of the dry part)

Molding: Stretch blow molding machine, extrusion blow molding machine (in each case preferably part of the wet end or sometimes also part of a dry end, e.g. with connection to the wet end by a long air transport), injection molding machine (own system area, but can also be part of the wet end or part of the dry end), mold filling machine (part of the wet end), preferably in each case designed as a circular runner, i.e. with a treatment carousel

Equipping: labeling machine, direct printing machine for direct printing on containers, in each case preferably as a circular runner, direct printing machine for direct printing on labels, banding machines for the head area (e.g. closure protection for corks), in each case preferably part of the wet end, but can also be part of the dry end

Distributing: Picking machines, diverters, turning and distributing machines, robots for sorting containers or packs by type, line distributors (each preferably part of the dry part)

Unpacking: gripper for containers to remove containers from crates, robot (in each case preferably part of the drying part or return part)

Sorting: Picking machines, diverters, turning and distributing machines, robots for sorting containers or packs by type, line distributors (in each case preferably part of the drying part or return part)

De-labeling: Devices for peeling off labels (preferably part of the return part)

Unscrewing: devices for unscrewing a closure seated on a container, unscrewers, uncorkers (preferably part of the return part)

Coating: Interior coating devices to improve the barrier properties of containers, particularly plasma coating devices (part of the wet or drying part)

Sterilizing: Continuous pasteurizers, apparatus for turning containers in hotfill systems to sterilize the cover, sterilization machines for tasking sterilant, such as hydrogen peroxide or peracetic acid, to container interior and/or exterior surfaces (preferably part of the wet end).

Filling: Piston fillers, bag fillers, bottle fillers, form fillers, pulp fillers, in each case preferably as circular runners (in each case part of the wet part)

Closing: Container closer, crown cork closer, screw closer, in each case preferably as a circular runner (in each case part of the wet part)

Cleaning: Rinsers, preferably as circular runners, cleaning machines for the detachment of labels and/or for caustic and/or for acid cleaning of reusable containers, cleaning apparatus for cleaning or sterilizing treatment devices (in each case part of the wet part).

Packaging: shrink packers, cartoning machines for packing groups of containers in cartons, trays or similar, wrapping machines for wrapping groups of containers with packaging material, banding machines, stretch foil packers, shrink tunnels, handle applicators for applying handles to container packs, erectors for cartons or trays, inserters for inserting containers into outer packaging (e.g. rates), paper packing machines for packing containers with paper blanks, combinations thereof (each part of the drying part)

Drying: Drying apparatus with nozzles for blowing off moisture on the outer surfaces of the containers, usually upstream of labeling or direct printing machines or machines for the production of adhesive containers (in each case preferably part of the wet or drying part)

Gluing: Pack production machine with nozzles for applying glue to containers and for combining these containers with other containers to produce a so-called glue pack, apparatus for providing packs containing containers with glue to secure packs of a pallet layer to further packs of this layer or to secure a layer to the adjacent layer above or below it (in each case preferably part of the drying part)

Palletizing: Stacking apparatus for stacking layers from packs or individual containers, interlayer insertion devices, robots (each part of the drying part).

Depalletizing: De-stacking apparatus for destacking layers, for example pushers for new glass bottles or cans, robots (in each case part of the dry or return part).

Transporting: Transporter belts or transport chains for transporting containers standing or lying on them, transport starwheels, feed chutes for closures or preforms or can rinsers (can be part of all areas).

The object is further achieved by a container treating method for treating containers according to the independent method claim. The method is carried out with a container treatment system having at least two container treatment devices, a detection apparatus and an evaluation apparatus, wherein the method comprises the steps of: detecting, with the detection apparatus, at least one operating state of the at least two container treatment devices, treating, with the at least two container treatment devices, a container by at least one of the following types of treatment, namely transporting, buffering, sorting, grouping, inspecting, heating, forming, shaping, equipping, grouping, distributing, unpacking, sorting, de-labeling, unscrewing, drying, coating, sterilizing, filling, sealing, cleaning, packing, palletizing, depalletizing, and evaluating, with the evaluation apparatus, the detection result of the at least one detection apparatus to determine the type of operating state detected.

The container treatment method achieves the same benefits as previously mentioned with respect to the container treatment system.

In the container treatment method described above, the treatment step can be performed at least partially before the detecting step.

Alternatively or additionally, the detecting step and the treatment step can be performed simultaneously at least some of the time.

It is possible for the detecting step to be performed intermittently with predetermined time intervals or continuously.

The object is further achieved by a container treating system for treating containers according to the independent system claim.

The container treatment system has at least two container treatment systems, each with a container treatment device for treating containers by at least one of the following types of treatment, namely transporting, buffering, sorting, distributing, unpacking, de-labeling, unscrewing, drying, grouping, inspecting, heating, forming, equipping, coating, sterilizing, filling, sealing, cleaning, packing, palletizing, depalletizing. The system further has a detection apparatus for detecting at least one operating state of at least one container treatment device of both container treatment systems, and an evaluation apparatus configured to evaluate the detection result of the detection apparatus with respect to the type of operating state detected.

The two treatment systems may have partly or entirely the same container treatment devices for treating containers, e.g. both each have a filler or both each have a packaging machine.

In particular, a detection apparatus may detect operating states of at least two container treatment devices that treat the containers in the same manner.

Other possible implementations of the invention also comprise combinations of features or embodiments described previously or below with respect to the exemplary embodiments that are not explicitly mentioned. In doing so, the person skilled in the art will also add individual aspects as improvements or additions to the respective basic form of the invention.

The invention is described in more detail below with reference to the accompanying drawing and with reference to exemplary embodiments. In the figures:

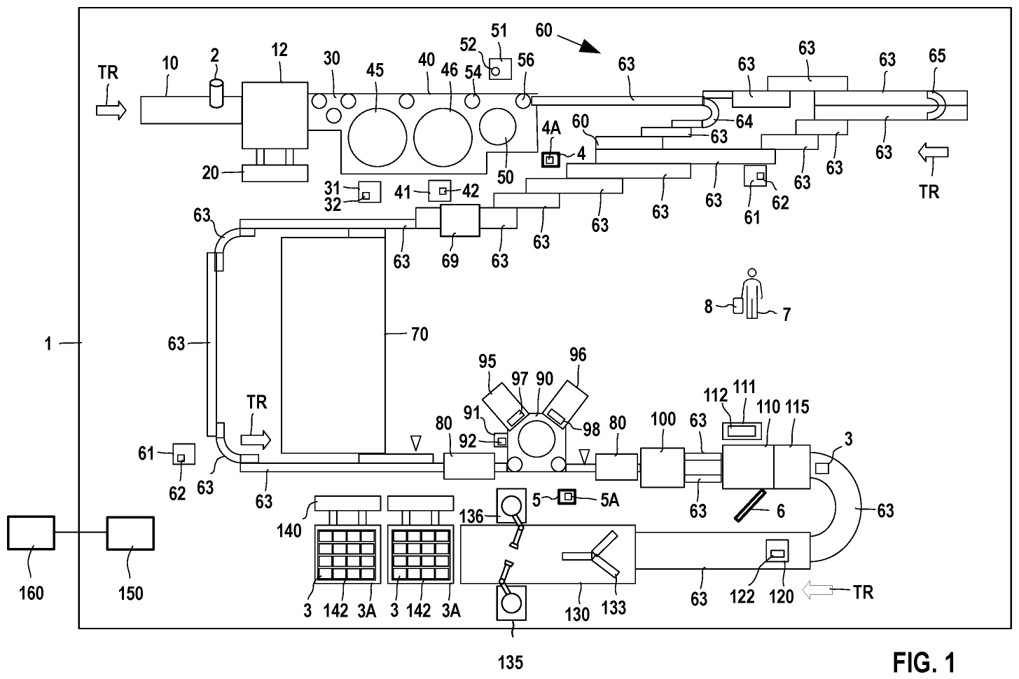

FIG. 1 shows a block diagram of a container treatment system in accordance with a first exemplary embodiment;

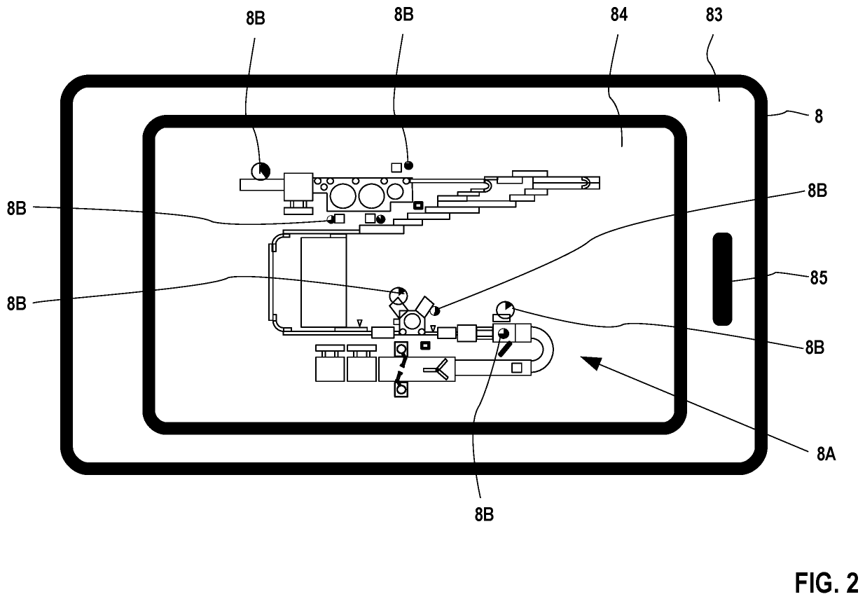

FIG. 2 shows a top view of a mobile display apparatus with a display for operating personnel of the container treatment system;

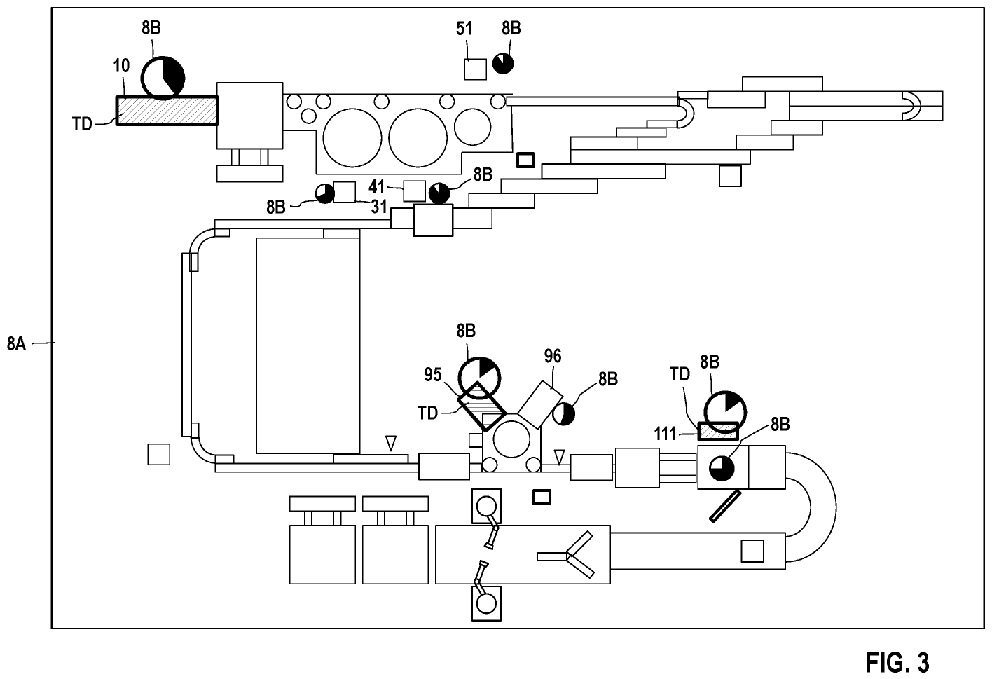

FIG. 3 to FIG. 5, respectively, show a different display relating to operating states of the container treatment system in accordance with the first exemplary embodiment;

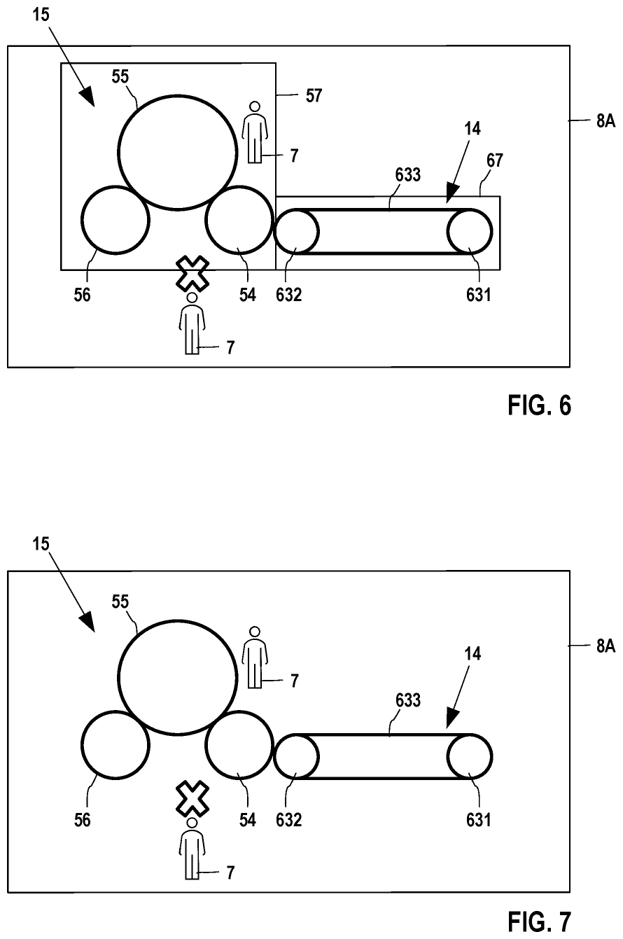

FIG. 6 shows an example of a display of an evaluation executable with the container treatment system in accordance with the first exemplary embodiment;

FIG. 7 shows another example of a display of an evaluation executable with the container treatment system in accordance with the first exemplary embodiment;

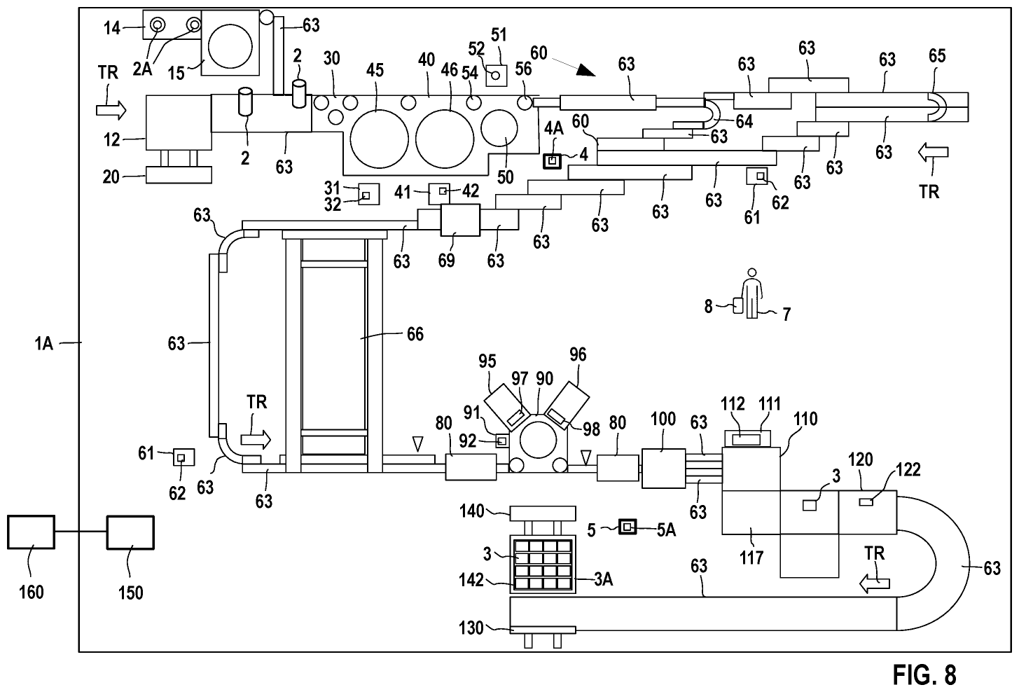

FIG. 8 shows a block diagram of a container treatment system in accordance with a second exemplary embodiment;

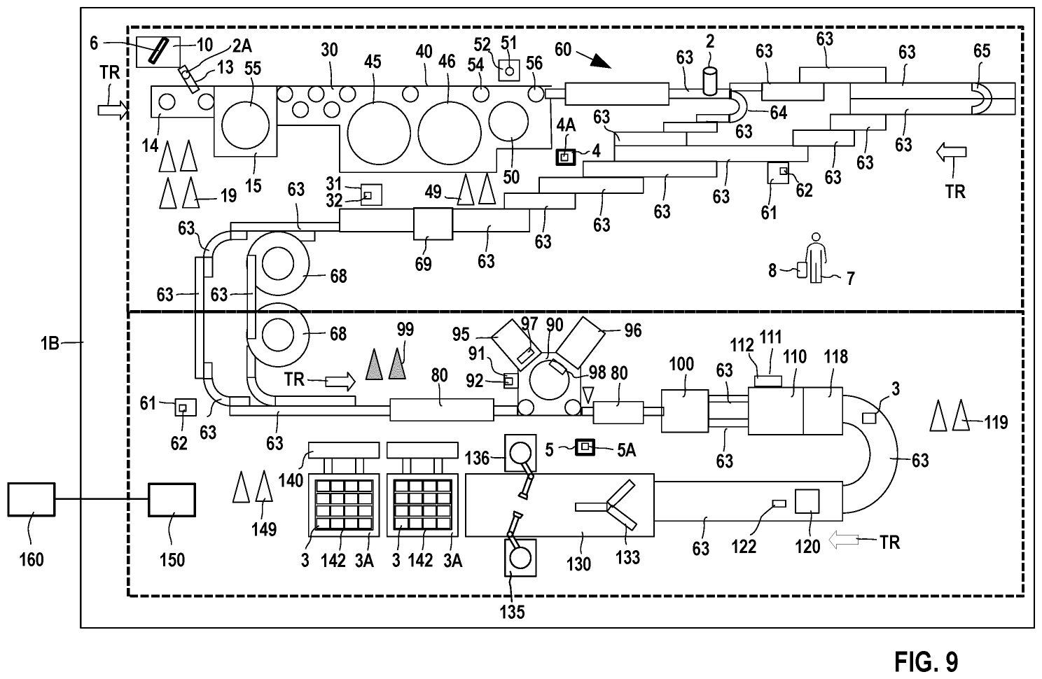

FIG. 9 shows a block diagram of a container treatment system in accordance with a third exemplary embodiment;

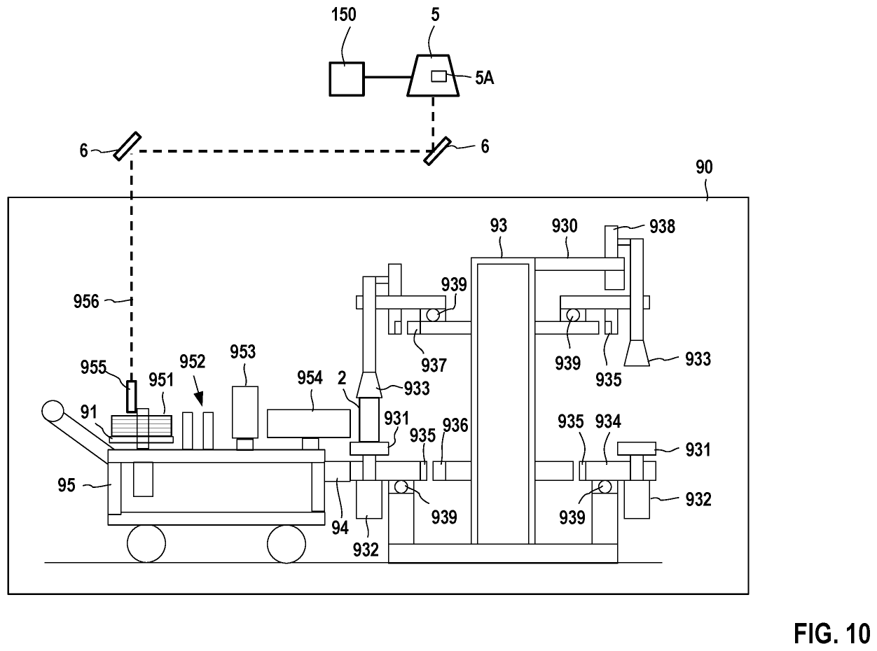

FIG. 10 shows a block diagram of a container treatment system in accordance with a fourth exemplary embodiment;

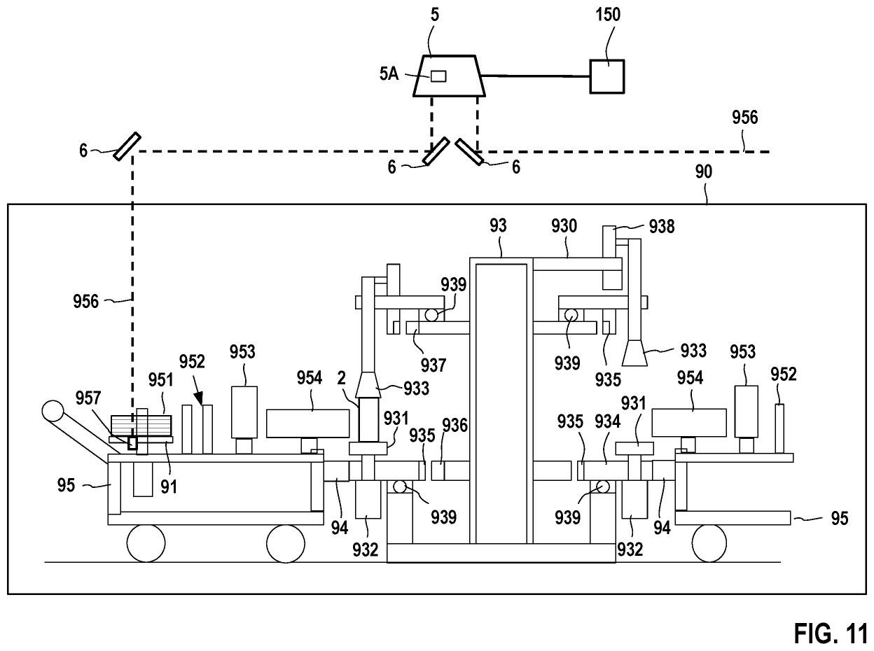

FIG. 11 shows a block diagram of a container treatment system in accordance with a fifth exemplary embodiment; and

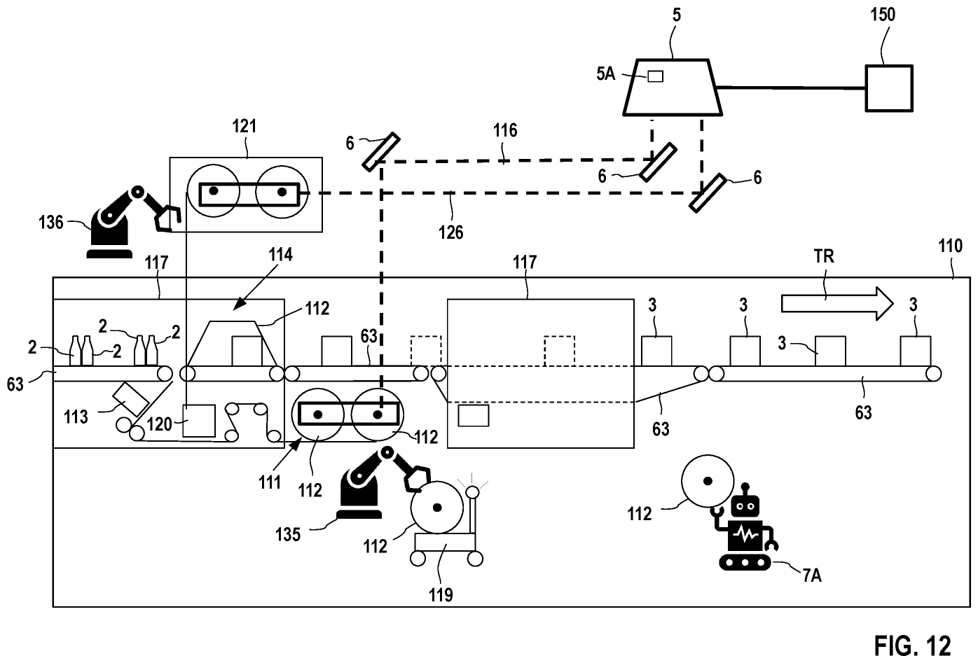

FIG. 12 shows a block diagram of a container treatment system in accordance with a sixth exemplary embodiment.

In the figures, identical or functionally identical elements are given the same reference numerals unless otherwise indicated.

FIG. 1 shows an example of a container treatment system 1. In the container treatment system 1 of FIG. 1, containers 2 are treated by a plurality of devices 10, 20, 30, 40, 45, 50, 60, 65, 69, 70, 80, 90, 110, 120, 130, 140 arranged in sequence one after another. The devices 10, 20, 30, 40, 50, 60, 69, 70, 80, 90, 110, 120, 130, 140 are downstream and/or upstream from one another. The devices 10, 20 are part of the return part. The devices 30, 40, 45, 50 60, 65, 69, 70, first 80, 90 form a wet section or “wet part” of the container treatment system 1 the transporters, e.g., 63 to position 90, are also included. The devices second 80, 90, 100, 110, 120, 130, 140 form a drying area or “drying part” of the container treatment system 1.

The containers 2 (a preform shall also be a container) shall be treated in the container treatment system 1, so that the container 2 is filled with a product 42 and packed in a predetermined packaging unit 3. The predetermined packaging unit 3 is a container (or an adhesive joint among containers 2) in which the containers 2 are arranged. The packaging unit 3 is grouped into layers 3A such that the containers 2 can be delivered to a customer for wholesale or retail sale. Depending on the embodiment, the container treatment system 1 can treat a plurality of containers 2 such that up to approximately 10,000 containers 2 per hour or up to approximately 96,000 containers 2 per hour or more containers 2 per hour can be discharged from the container treatment system 2 ready filled, equipped (e.g., printed or labeled), and packaged.

In FIG. 1, the system 1 for treating cans is designed as a container 2. Alternatively, the system 1 of FIG. 1 can be designed for treating glass containers, such as a yogurt jar or jam jar, or glass bottles as containers 2. In FIG. 1, only one container 2 is shown for clarity, even if the container treatment system 1 treats a plurality of containers 2 in succession and/or at least at times simultaneously.

The container treatment system 1 has at least one detection apparatus 4, 5, which is designed to detect at least one operating state of the system 1. The at least one detection apparatus 4, 5 is arranged to detect the operating state of at least two devices of the devices 10, 20, 30, 40, 45, 50, 60, 65, 69, 70, 80, 90, 110, 120, 130, 140. The container treatment system 1, in particular its devices 10, 20, 30, 40, 50, 60, 69, 70, 80, 90, 110, 120, 130, 140, can/can be operated by at least one operator 7.

In the example of FIG. 1, the detection apparatus 4 is arranged to detect the current operating state of the devices 10, 20, 30, 40, 45, 50, 65 and at least partially of the devices 60, 69, 70. Additionally or alternatively, the apparatus 4 may sense intermediate spaces between the devices 10, 20, 30, 40, 45, 50, 60, 69, 70.

The detection apparatus 4 thus detects the operating states of the wet area of the container treatment system 1. The detection apparatus 4 performs intermittent detection at predetermined time intervals or continuous detection.

In each type of detection, the detection apparatus 4 may take either a photograph or a video.

The detection apparatus 4 can perform one of intermittent detection or continuous detection, depending on the detection result of the operating states.

The detection apparatus 5 of FIG. 1 is arranged to detect the current operating state of the devices 80, 90, 110, 120, 130, 140 and at least partially of the devices 60, 69, 70. Additionally or alternatively, the apparatus 5 may sense intermediate spaces between the devices 60, 69, 70, 80, 90, 110, 120, 130, 140. The detection apparatus 5 thus detects the operating states of the drying area of the container treatment system 1.

The detection apparatus 5 performs intermittent detection at predetermined time intervals or continuous detection. In each type of detection, the detection apparatus 4 may take either a photograph or a video.

The detection apparatus 5 can perform one of intermittent detection or continuous detection, depending on the detection result of the operating states.

The detection of determined devices is shown here only as an example; a labeling machine 90 and a pasteurizer 70 could alternatively be detected only by the detection apparatus 4. Likewise, it is conceivable to detect all or only two, three, four . . . of the devices shown with only one detection apparatus 4 or with three detection apparatuses (not shown).

To determine the type of detection, the detection apparatus 4 has an evaluation apparatus 4A. The detection apparatus 5 has an evaluation apparatus 5A to determine the type of detection.

The at least one detection apparatus 4, 5 is arranged at a distance of at least 3 m, preferably at least 5 m, above the container treatment system 1.

The at least one detection apparatus 4, 5 may be arranged statically. Alternatively, the at least one detection apparatus 4, 5 is arranged to be rotatable or displaceable about or along at least one axis.

For this purpose, the at least one detection apparatus 4, 5 may be mounted on a vehicle movable in the room in the at least one axis. Alternatively, the at least one detection apparatus 4, 5 is designed as a drone. Irrespective of the aforementioned embodiments, the detection field of at least two detection apparatuses 4, 5 may overlap at least partially and/or at least temporarily.

It is alternatively or additionally possible not to detect certain areas of the container treatment system 1.

Each detection apparatus 4, 5 preferably has at least one camera. At least two cameras can be movable relative to one another, in particular rotatable or displaceable. At least two cameras may have a field of view that at least partially and/or at least temporarily overlaps. The detection field of the at least one detection apparatus 4, 5 is directed in the direction of the respective devices 10, 20, 30, 40, 50, 60, 69, 70, 80, 90, 110, 120, 130, 140 of the system 1 whose operating state is to be detected by the detection apparatus 4, 5, as previously described.

Each of the detection apparatuses 4, 5 may additionally or alternatively have an infrared camera. As a result, the corresponding detection apparatus 4, 5 is designed to detect temperatures. For example, the detection apparatus 4, 5 may detect and use temperature to control devices 10, 20, 30, 40, 50, 60, 69, 70, 80, 90, 110, 120, 130, 140 of the system 1. In particular, the temperature may be used to control a drying device 80 upstream of the device 90.

During detection, it may be dark in the room or building in which the container treatment system 1, or at least parts 10, 20, 30, 40, 50, 60, 69, 70, 80, 90, 110, 120, 130, 140 thereof, is located.

The respective evaluation apparatuses 4A, 5A may select the need for continuous detection or detection with predetermined time intervals depending on a speed or temperature present when treating the containers 2 with any of the devices 10, 20, 30, 40, 50, 60, 69, 70, 80, 90, 110, 120, 130, 140. For this purpose, the respective evaluation apparatuses 4A, 5A optionally evaluate at least one detection result from at least one additional detection apparatus or sensor which is designed for the detection of temperature and/or speed. The at least one detection apparatus 4, 5 is configured for receiving and transmitting data corresponding to the detection result for wireless and/or wired data transmission.

Each of the evaluation apparatuses 4A, 5A evaluates the respective detection result. Here, the evaluation apparatus 4A, 5A can compare the respective detection result with target states. Additionally or alternatively, the evaluation apparatus 4A, 5A can compare the respective detection result with a detection result that was previously recorded, in particular before a predetermined period of time.

Instead of the two evaluation apparatuses 4A, 5A, only one evaluation apparatus 4A can alternatively be provided for two or a plurality of detection apparatuses.

In addition, the respective evaluation apparatus 4A, 5A generates an indication for the operator 7, which the evaluation apparatus 4A, 5A outputs to a display apparatus 8 for the operator 7.

In the example of FIG. 1, the display apparatus 8 is a mobile, preferably portable, display apparatus. Alternatively or additionally, the display apparatus 8 can be a, at least temporarily, statically arranged display apparatus. This is described in more detail below with reference to FIG. 2 to FIG. 5.

Each evaluation apparatus 4A, 5A may have software in particular. The software is configured to execute the function of the evaluation apparatus 4A, 5A and thus to evaluate the detection results of the at least one detection apparatus 4, 5.

At least one of the evaluation apparatuses 4A, 5A can perform its evaluation at least partially together with the other of the evaluation apparatuses 4A, 5A. In this case, one of the evaluation apparatuses 4A, 5A acts as the master. The at least one other evaluation apparatus 4A, 5A acts as a slave, which is subordinate to the master in terms of control.

At least one of the evaluation apparatuses 4A, 5A can perform its evaluation at least partially together with a control apparatus 150 of the container treatment system 1 or a control apparatus of at least one of the devices 10, 20, 30, 40, 50, 60, 69, 70, 80, 90, 110, 120, 130, 140.

Additionally or alternatively, the evaluation apparatus 4A, 5A is optionally configured to use the evaluation of the detection result of the associated detection apparatus 4, 5 based on data of the display apparatus 8 and/or the external apparatus 160 storing at least one indication detected and outputted in the preceding operation of the container treatment system 1.

The control apparatus 150 of the container treatment system 1 can be designed in particular as a programmable logic controller (PLC). The control apparatuses of the devices 10, 20, 30, 40, 50, 60, 69, 70, 80, 90, 110, 120, 130, 140 are not represented in the figures. The control apparatus 150 may have at least a part of the evaluation apparatus 4A, 5A.

At least one, preferably all, of the control apparatuses of the devices 10, 20, 30, 40, 50, 60, 69, 70, 80, 90, 110, 120, 130, 140 may be/are particularly a programmable logic controller (PLC).

The control apparatus 150 of the container treatment system 1 is connected to an external apparatus 160. This allows the system 1 to be integrated into a remote maintenance system. In particular, employees in another room can access at least one of the detection apparatuses 4, 5 to observe the operator(s) 7 for troubleshooting.

In this manner, it is also possible to direct the operator(s) 7 to the locations of the system 1 where activities are to be performed. Alternatively, the external apparatus 160 belongs to an external company whose employees should have access to the control apparatus 150 of the container treatment system 1 and/or the at least one detection apparatus 4, 5.

The connection or data exchange between the control apparatus 150 and the external apparatus 160 may be implemented at least in part via the Internet.

In accordance with FIG. 1, the container treatment system 1 has a container magazine 10, which in the example of FIG. 1 is designed as a can magazine. Empty containers 2 are kept in the container magazine 10, particularly on pallets 12. The thus unfilled containers 2 are to be treated in the container treatment system 1, in particular after removal from a pallet 12, which is also referred to as depalletizing, are to be filled with a product, and finally are to be assembled as a filled and appropriately labeled or equipped container 2 packed into a predetermined packaging unit 3 in such a way that the containers 2 can be delivered to a customer. For this purpose, the containers 2 are each transported through the container treatment system 1 in a transport direction TR. This is described in more detail below.

For depalletizing, the container treatment system 1 has a depalletizing device 20. The depalletizing device 20 removes the empty containers 2 individually from a pallet 12 and feeds the containers 2 to a rinsing device 30.

The rinsing device 30 has a tank 31 in which rinsing liquid 32 is stored. In the rinsing device 30, the containers 2 are rinsed with the rinsing liquid 32. This cleans the empty containers 2 in such a manner that the containers 2 can be fed to a filling device 40 for filling. Contrary to the representation, the rinsing device 30 may be configured as a chute along which nozzles are arranged for discharging rinsing liquid into the cans.

The filling device 40 has at least one tank 41 for receiving a product 42 to be filled into the containers 2. The product 42 may have different consistencies, particularly being liquid and/or solid and/or at least partially gaseous or a powder. For example, the product 42 is a food product, in particular a carbonated or non-carbonated beverage, yogurt, jam, porridge, vegetables, nuts, etc., or a cleaning means or a cosmetic product, or paint or tablets, etc. For filling, the filling device 40 has two filling aggregates 45, 46, by which the containers 2 are held and transported accordingly, such that the containers 2 can be filled with the product 42. The filling device 40 passes the filled containers 2 individually, one by one, to a closing device 50 by means of a transport starwheel 54. Alternatively, reference numerals 45 may be rinsers and position numerals 30 may be transporters only.

The closing device 50 has at least one magazine 51 for receptacles for container closures 52, with which the filled containers 2 are to be closed. The container closures 52 are can lids when cans are to be treated as containers 2. The container closures 52 are, for example, crown corks or screw caps if the containers 2 are made of glass, particularly as glass bottles or glass containers. The closures 52 are transported along a closure chute, not shown, from the closure magazine 51 to the capping device 50, where they are applied to the containers 50. The closing device 50 passes the filled containers 2 individually, one by one, to a transport device 60 by means of a transport starwheel 56.

As can be seen, the devices 30, 45, 46, 50 may be treatment carousels, also called circular runners.

In particular, filler 46 and closer 50 may each have a plurality of container treating stations (filling valves and closing heads) along their circumference, which are arranged at equidistant distances from one another and which rotate in a circle, particularly continuously, during treating (filling and closing).

The transport device 60 has at least one tank 61 for receiving lubricant 62. In addition, the transport device 60 has a plurality of transporters 63, optional switches 64 and buffers 65.

Each transporter 63 and a diverter 64 has at least one belt arranged transverse to the transport direction TR or the respective transporter 63 or diverter 64 of the transport device 60. The belts can be designed as chains with a plurality of chain links on which the filled containers 2 are transported in an upright position. The chains are designed as endless chains that run around deflection rollers of the respective transporter 63 or diverter 64. The chains of transporters 63 can circulate at different speeds. The lubricant 62 is provided to lubricate the chains to assist in sliding the containers 2. The lubricant 62 can be used in particular during lateral transfer from transporter 63 to transporter 63.

The diverter 64 and buffer 65 are used to control the flow of containers between the closing device 50 and the downstream devices 70, 80, 90, 100, 110, 120, 130, 140. The diverter 64 can be used to transport the containers 2 to a pasteurizer 70 more quickly, i.e., without intermediate buffering. Depending on the product 42, the containers 2 may be treated (sterilized by heat) in the pasteurizer 70 or passed past the pasteurizer 70 with transport controls 63.

If more time is needed, for example because the pasteurizer 70 and/or subsequent devices 70, 80, 90, 100, 110, 120, 130, 140 are/is not yet ready for treating the containers 2 or are temporarily running slower than the devices 10, 20, 30, 40, 50, the diverter 64 is set in such a way that the containers 2 are not transported via the diverter 64 but up to the buffer 65. The buffer 65 deflects the previous transport direction TR of the containers 2 in the opposite direction. As a result, the containers 2 are conveyed from the buffer 65 to the pasteurizer 70 via the downstream transporters 63.

The buffer 65 could alternatively or additionally be arranged in the mold between the pasteurizer 70 and the labeling machine 90 and/or between the labeling machine 90 and the packer.

The buffer 65 can be adjusted on the transporters 63 from the position shown in FIG. 1 in such a manner that the buffer 65 is arranged closer in the direction of the adjacent transporters 63. This allows the transporters 63 to pick up fewer containers 2. Alternatively, the buffer 65 can be adjusted from the position shown in FIG. 1 such that the buffer 65 is arranged, for example, at the free end of the transporters 63. This allows the transporters 63, on which the buffer 65 is arranged, to accommodate the maximum number of containers 2.

The transport device 60 can thus be used to control the number of containers 2 currently in the transport device 60 ahead of subsequent devices 70, 80, 90, 100, 110, 120, 130, 140. Still further, the transport device 60 can control the speed at which the containers 2 are fed to the downstream devices 70, 80, 90, 100, 110, 120, 130, 140. The wider a transporter 63 is, the more containers 2 can be transported next to each other in so-called mass transport. In particular, wider transporters 63 can be used to reduce the transport speed of the containers 2. The width of the individual transporters 63 can also be controlled by sliding railings that adjust the width of the transporters 63 between a maximum width and a minimum width. Additionally or alternatively, the speed of each transporter 63 can be controlled to accelerate or decelerate the containers 2 from one transporter 63 to a downstream transporter 63.

In particular, at least one chain of a transporter 63 may circulate at a different speed than at least one other chain of a transporter 63.

At least one inspection device 69 may be provided on the transport device 60 to inspect the containers 2. If a container 2 does not meet the required quality and is therefore to be classified as defective, the container 2 is sorted out by the inspection device 69.

The pasteurizer 70 is configured for pasteurizing food products, such as beer, etc., in the containers 2. After pasteurization, the containers 2 are forwarded to a drying device 80 by at least one transporter 63.

The drying device 80 is configured to dry the containers 2. The containers 2 are thereby dried in such a manner that the containers 2 are suitably dried for subsequent treatments with the downstream devices 90, 100, 110, 120, 130, 140. After that, the containers 2 are forwarded to an equipment device 90.

The equipment device 90 has at least one tank 91 for receptacle of glue 92 and at least one equipment aggregate 95, 96. For example, the equipment aggregate 95 is a labeling aggregate that uses the glue 92 to apply labels 97 to the containers 2. For example, the equipment aggregate 96 is a printing aggregate that prints 98 directly on the containers 2 and/or at least partially on the labels 97. The print 98 may be lettering, such as a best before date or manufacturing date, or may have a predetermined image as the label or at least a part of the label. In addition, the equipment device 90 may have a unit for coating the containers 2 with a predetermined coating, particularly as a pretreatment of containers to be printed by another aggregate.

In the equipment device 90, the containers 2 are held and transported such that the containers 2 are moved past the at least one equipment aggregate 95, 96 for the intended equipment. The equipment device 90 passes the filled containers 2 individually, one by one, to a downstream drying device 80.

Like the filler 46, the equipment device may be designed as a circular runner, wherein, however, treating is performed at least in part (rotating the containers may be performed on the carousel) by a stationary aggregate.

The second drying device 80 dries condensate formed in the meantime on the surface of the container (in particular when cold product is filled in the filler 46 and no pasteurizer 70 or pasteurization is provided and when the transport between labeler 90 and packer is longer) and/or the print (ink) 98 on the containers 2. The drying device 80 performs drying such that the equipped containers 2 are suitably dried for subsequent treatments with the downstream devices 100, 110, 120, 130, 140. The second, or possibly all, drying devices 80 can also be dispensed with in some cases.

Thereafter, the containers 2 are forwarded to a distribution device 100.

The distribution device 100 distributes the containers 2 to two or more transport tracks. Each transport track can be formed by a transporter 63. Thereafter, the containers 2 are forwarded to a packing device 110 (also called a “packer”).

The packaging device 110 has a magazine 111 for a packaging material 112. The packaging material 112 is in particular foil or other suitable material, possibly also adhesive. In the packaging device 110, the containers 2 are packed with the packaging material 112 into a predetermined packaging unit 3. For this purpose, the containers 2 are grouped into groups of, for example, at least two containers 2. The containers 2 are then bound with the packaging material 112, particularly foil, to form a pack. A mirror 6 is provided on the packaging device 110 of FIG. 1 for the detection apparatus 5. The mirror 6 is arranged in such a manner that the detection apparatus 5 can view the unwinding of the foil. The mirror 6 can link an optical signal from the container treatment system 1, particularly the magazine 111, to the detection apparatus 5. In addition, the packaging device 100 has a shrink tunnel 115 with which the foil (packaging material 112) is shrunk onto the grouped containers 2 to form the container bundle as a packaging unit 3.

Alternatively, the packaging device 110 may be an adhesive pack manufacturing device by means of which containers 2 are connected to one another via adhesive applications to form packs 3 comprising two or more containers. The adhesive pack manufacturing device may have nozzles that apply adhesive dots to the outer surfaces of the container. Further, it may have a merging device that brings the containers provided with adhesive together for their bonding.

The packaging device 110 outputs the predetermined packaging units 3 to a transporter 63, which forwards the packaging unit 3 to an optional handle assembly device 120.

The handle assembly device 120 attaches a handle 122 to each packaging unit 3. A magazine not shown may also be provided for the handle 122. The handle 122 facilitates the transport of the packaging unit in the trade. The packaging unit 3 is forwarded to a sorting device 130 by a transporter 63.

The sorting device 130 may have, for example, a robot 133 in the form of a tripod above the transport plane to arrange the packaging units 3 in a layer scheme by rotation and/or displacement. Alternatively or additionally, robots 135, 136 can be provided which arrange the packaging units 3 in layers 3A, in which the packaging units 3 (also called packs) are arranged, for example, in rows next to one another and one after the other. The layers 3A are then forwarded to a palletizing device 140.

The palletizing device 140 is configured to arrange the layers 3A output by the sorting device 130 on pallets 142. The loaded pallets 142 can thus be delivered for retail sale of the containers 2.

Depending on the spatial conditions, the container treatment system 1 may have a different arrangement of the devices 10, 20, 30, 40, 50, 60, 69, 70, 80, 90, 110, 120, 130, 140 than shown in FIG. 1 and described previously. In particular, the container treatment system 1 may be arranged in at least two separate rooms.

Additionally or alternatively, it is conceivable that all of the devices 10, 20, 30, 40, 50, 60, 69, 70, 80, 90, 110, 120, 130, 140 are arranged in a long row one after the other without requiring deflections of the transport direction TR between the individual devices 10, 20, 30, 40, 50, 60, 69, 70, 80, 90, 110, 120, 130, 140.

FIG. 2 shows a display 8A that can be displayed by the operator 7 during operation of the detection apparatuses 4, 5 for the container treatment system 1 of FIG. 1 using the display apparatus 8. In the example of FIG. 2, the display apparatus 8 is a mobile display apparatus, for example a mobile telephone with display apparatus, particularly a smartphone, or a tablet PC (PC=personal computer) or similar. The display apparatus 8 has a housing 83, a screen 84, and at least one manually operable operating element 85. The screen 84 may be a touch-sensitive screen (touchscreen).

The display 8A contains indications 8B that a detection apparatus 4 or, in the case of more than one, the detection apparatuses 4, 5 have output to the display apparatus 8.

The indications 8B may comprise, for example, a filling condition of magazines or tanks.

The indications 8B can alternatively or additionally indicate to the operator 7 which activities in the container treatment system 1 are due next and are therefore to be performed by the operator. In FIG. 2, for the sake of clarity, not all indications 8B are provided with a reference numerals.

FIG. 3 shows an enlarged representation of the display 8A of FIG. 2. The display 8A may include an indication 8B on the level of the magazine 10, an indication 8B on the level of the tank 31 for the rinsing liquid 32 of the rinsing device 30, an indication 8B on the level of the tank 41 for the product 42 to be filled into the containers 2 by the filling device 40, an indication 8B on the level of the magazine 51 for container closures 52 of the closing device 50, an indication 8B of the filling level of a magazine for labels 92 of the unit 95 of the equipment device 90, an indication 8B of the filling level of a magazine for labels 92 and/or ink of the unit 96 of the equipment device 90 and/or an indication 8B of the filling level of the magazine/tank 111 for film 112 or adhesive of the packaging device 110.

In addition, an optical marking TD can be used to indicate at which device elements of the devices 10, 20, 30, 40, 50, 60, 69, 70, 80, 90, 110, 120, 130, 140 of the system 1 activities are to be performed.

The display 8A can be configurable with regard to the number and type of indications 8B. For example, a machine operator can set the display 8A in such a manner that only indications 8B about fill levels are displayed if they fall below a certain value.

In accordance with the display 8A of FIG. 3, the magazine 10, the unit 95 and the magazine 111 are marked with a visual identification TD in the form of a hatching. Alternatively or additionally, another pattern or image can be used for marking TD. Optionally, the optical marking TD can be made with at least one color that is different from other colors of the display 8A. In addition or alternatively, the TD marking can be visually indicated by flashing.

Thus, the display 8A of FIG. 3 quickly conveys to the operator 7 in a visually perceptible manner that the fill levels of the magazine 10, the unit 95, and the magazine 111 will not be sufficient for long and that the material therein will soon run out. Thus, the display 8A indicates what type of activity and where in the system 1 is to be performed in the near future. In the near future comprises that the activity is to be carried out particularly next.

The display 8A can prioritize the activities such that it can be seen which activities are particularly urgent, in particular to be carried out first.

The operator 7 can therefore use the display 8A to take the correct action in good time so that the operation of the container treatment system 1 does not have to be interrupted, but can continue as intended.

Alternatively or additionally, at least one of the tanks 31, 41, 61 or magazines 51 etc. may be provided with a glass window, in particular with a calibration, such that the associated apparatus 4, 5 can directly detect the filling level of the tank 31, 41, 61 or magazine 51, etc.

Alternatively or additionally, the at least one evaluation apparatus 4A, 5A can output a signal to the magazine 10 and/or the unit 95 and/or the magazine 111 so that the magazine 10 and/or the unit 95 and/or the magazine 111 automatically replenishes the required material.

Alternatively or additionally, the detection apparatus 5 can also forward the detection result to a database. For example, the database can reflect the inventory of a warehouse. This allows the detection result to be used to automatically reorder materials, such as labels 92, ink, film 112, rinsing liquid 32, product 42, lubricant 61, etc., when the level in the corresponding magazine or tank is nearing its end.

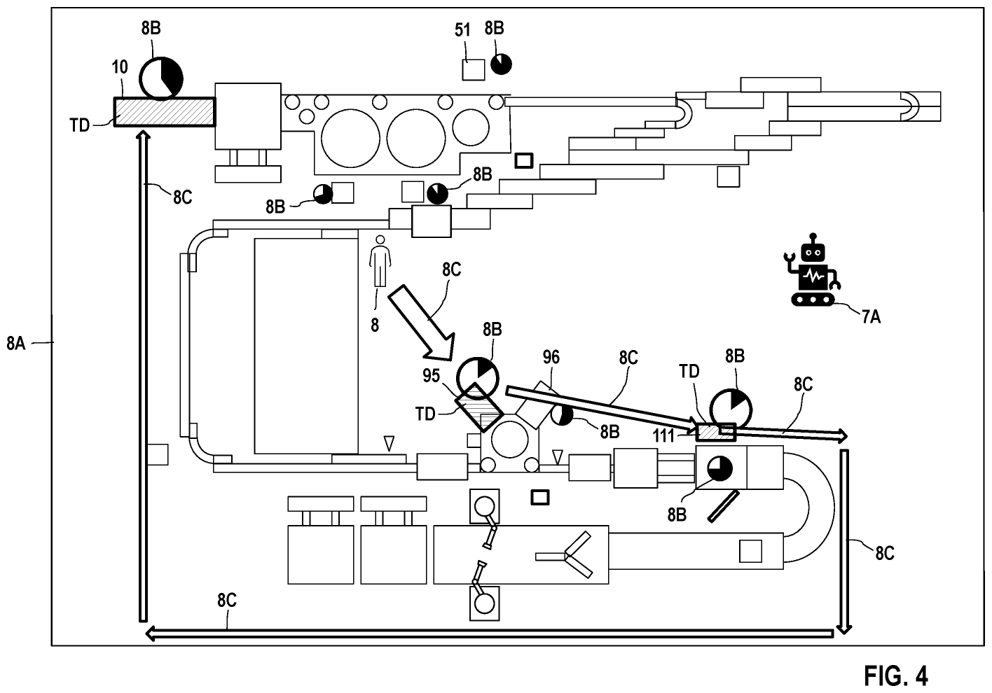

FIG. 4 shows another example of a display 8A on the display apparatus 8 of FIG. 2. In the example of FIG. 4, the operator 7 is also shown where the operator 7 is located in the system 1.

Optionally, the display 8A may additionally or alternatively indicate where a mobile robot 7A, if present, is located in the system 1. The robot 7A can be used in particular for changing fixture elements when the system 1 is to be changed from manufacturing a first predetermined container type to a second predetermined container type. The first predetermined container type is, for example, a glass bottle 2 with a capacity for 200 ml of cola. The second predetermined type of container is, for example, a glass bottle 2 with a capacity for 500 ml of lemonade.

Alternatively or additionally, the at least one evaluation apparatus 4A, 5A may output a signal to the robot 7A so that the robot 7A fills up the magazine 10 and/or the aggregate 95 and/or the magazine 111 as required.

In addition, the operator 7 is shown with indications 8C which path the operator 7 and, if necessary, a robot in parallel should cover in the system 1 in order to be able to complete the pending activities particularly efficiently and/or in accordance with their urgency.

If all work is done exclusively by robot 7A, a display is not absolutely necessary—the data with the paths/activities can be transmitted to the robot without a display in this case, particularly wirelessly.

The display of the way can contain not only a room in which the system 1 is placed. If required, a display for more than one room is possible, in particular over the entire premises. Bearings, for example, can also be displayed.

The indications 8C are also generated by the at least one detection apparatus 4, 5, in particular the evaluation apparatus(es) 4A, 5A, from at least one detection result. For this purpose, the at least one detection apparatus 4, 5 can additionally use detection data of at least one position sensor. The at least one detection apparatus 4, 5 outputs signals to the display apparatus 8 of FIG. 2 to display the indications 8C, as shown as an example in FIG. 4.

The operator 7 is therefore even better supported with the aid of the display 8A of FIG. 4 in order to be able to take the correct measures in good time so that the operation of the container treatment system 1 does not have to be interrupted, but can continue as intended.

The display 8A may take into account path optimization and/or time optimization in creating the sequence of activities to be performed next, in particular taking into account predetermined or historical data or data on the current output rate of the container treatment system. For example, refilling a more remote magazine or tank may be more urgent than refilling a closer magazine or tank, but it is known that refilling the closer magazine or tank is still feasible before the more remote magazine or tank is empty, thus the display 8A specifies by an indication 8C that the closer magazine should be refilled first. In another example, it may be known that a system stop (for other reasons) is pending or currently present—in this case, the activities can also be reprioritized away or time-optimized.

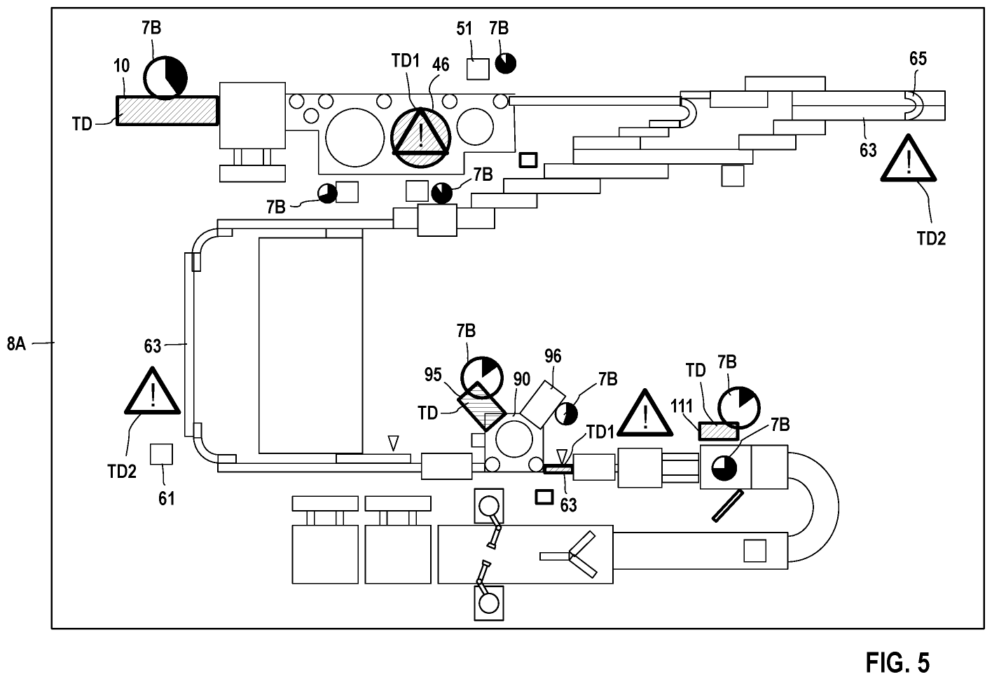

FIG. 5 shows yet another example of a display 8A on the display apparatus 8 of FIG. 2. In the example of FIG. 5, in addition to the operating states of FIG. 3, there are currently fault states in the system 1 and, for example, maintenance work to be carried out.

In the example shown, a container 2 has currently burst in the unit 46 of the filling device 40, so that broken pieces in the filling device 40 have to be removed. In addition, a container 2 has fallen over at the transporter 63 at the outlet of the equipment device 90, causing a jam. The display 8A visually indicates these two error states to the operator 7 with a visual indicator TD1. The TD1 optical marking has a different design than the TD optical marking. This allows fault states to be reliably distinguished from the other operating states, such as filling states, etc. The TD1 visual identifier may also contain text indicating the nature of the fault and/or the type of activity to be performed.

In addition, visual markings TD2 are shown to the operator 7 in the display 8A of FIG. 5. A visual marking TD2 is indicated, for example, on the transporter 63 with the buffer 65, namely that the bearing for a buffer slide of the buffer 65 is to be relubricated.

These two maintenance states will be visually indicated with a different optical marking than the optical marking TD1 and also different from the optical marking TD. This allows maintenance states and fault states to be reliably distinguished from the other operating states, such as fill states, etc. The TD2 visual marking may also contain text indicating the type of maintenance required and/or the type of activity to be performed.

The operator 7 is therefore even better supported with the aid of the display 8A of FIG. 5 in order to be able to take the correct measures in good time so that the operation of the container treatment system 1 does not have to be interrupted, but can continue as intended.

FIG. 6 shows yet another example of a display 8A on the display apparatus 8 of FIG. 2. In the example of FIG. 6, a representation is shown of where operators 7 are currently located relative to a device 14, 15 of the container treatment system 1 in the system 1. As an example, a combination of forming device or stretch blow molding machine 15 and heating device or oven 14 is shown. Of course, a similar indication 8A may be made for any other of the devices 10, 20, 30, 40, 50, 60, 60, 69, 70, 80, 90, 110, 120, 130, 140 of the container treatment system 1.

The at least one detection apparatus 4, 5 can use data from light barriers or contact switch signals of the machine guard or combinations thereof for this purpose.

Alternatively, the light barriers can transmit their radiation themselves to the at least one detection apparatus 4, 5. The operator(s) 7 interfere with the optical transmission of the light barrier signals. Accordingly, an interruption of a light beam, can be used to disable or not trigger an action in the system 1 when an operator(s) 7 is in the vicinity.

In the example of FIG. 6, the at least one detection apparatus 4, 5 has detected that a first operator 7 is currently inside an enclosure 57 of the device 15. In the enclosure 57, the containers 2 are guided by an infeed transport starwheel 54 to a stretch blow molding machine carousel 55. The carousel 55 passes the containers 2 to an outlet transport starwheel 56, which is arranged at an outlet from the device 15. The star 56 passes the containers 2 to a transporter 63, for example, which is not shown in FIG. 6. The oven 14 has a first deflection roller 631, a second deflection roller 632, and at least one chain 633. The chain 633 is wrapped around the deflection rollers 631, 632 such that the at least one chain 633 can pass around the deflection rollers 631, 632, as previously mentioned with respect to FIG. 1. The oven 14 is surrounded by an enclosure 67. A second operator 7 is currently located outside the enclosure 57. Moreover, the two operators 7 are located on two different sides of the device 15 and, moreover, of the oven 14. Left: blowing wheel and transfer stars—Right: the oven chain

The at least one detection apparatus 4, 5 thus detects the position in which the operators 7 are located relative to at least one device 14, 15 and evaluates with the corresponding apparatus 4A, 5A whether safety risks exist and what action should therefore be taken. One such action could be to enable or disable individual functions for operating the at least one device 14, 15.

For example, if the first operator 7 wishes to perform a rotation of the stretch blow molding machine carousel 55 during a maintenance or changeover (e.g., blow mold change) of the device 15, the at least one apparatus 4, 5 determines that the second operator 7 on the other side of the device 15 is to be alerted. Additionally or alternatively, the at least one apparatus 4, 5 may determine from the current position of the operators 7 at the device 15 that a rotation of the carousel 55 is to be inhibited. Additionally or alternatively, the at least one apparatus 4, 5 may determine whether a door of the enclosure 57 is to be locked. This is shown as an example with the white cross in FIG. 6.

The second operator 7 can be warned visually and/or acoustically with the display apparatus 8 and/or an additional display apparatus, in particular a viewing light with a warning tone, on the device 15.

In contrast to the device 15, the equipment device 90 requires, for example, safety precautions to be taken when an aggregate 95 is changed at one working position and a label roll change is performed by another operator 7 at the opposite position, which cannot be seen.

When the at least one detection apparatus 4, 5 detects such an operating state, the at least one detection apparatus 4, 5 controls the equipment device 90 to inhibit raising or lowering of the other unit 96 arranged at the opposite position.

Depending on the detected operating state, the at least one detection apparatus 4, 5 triggers an emergency stop of the at least one device 14, 15 and/or the container treatment system 1. An emergency stop can also control the at least one detection apparatus 4, 5 to avoid a collision with driverless, e.g. the robot 7A shown, or non-driverless transport systems. For this purpose, the at least one detection apparatus 4, 5 can additionally be connected to a controller of such transport systems.

Such controlling is performed by the at least one detection apparatus 4, 5, in particular when it is detected that an operator 7 could be injured.

In accordance with FIG. 7, the at least one detection apparatus 4, 5 is designed in such a manner that protection by the enclosures 57, 67 is not required. Therefore, there are no enclosures 57, 67.

Generally speaking, at least one of the at least two container treatment devices is substantially designed without machine guarding.

In this case, the at least one detection apparatus 4, 5 controls all warnings related to critical operating states in such a timely manner that no safety risks to operator(s) 7 and/or other parts of the system 1 can occur.

In addition, the at least one detection apparatus 4, 5 controls the devices 14, 15 in such a manner that parts of the devices 14, 15, in particular the enclosures 57, 67, are blocked in such a manner that no safety risks for operator(s) 7 and/or other parts of the system 1 can occur.

In general, for the two states in accordance with FIG. 6 and FIG. 7, it is possible for the same device of the devices 10, 14; 15; 20, 30, 40, 50, 60, 69, 70, 80, 90, 110, 120, 130, 140 of the container treatment system 1 to be operated simultaneously by two operators 7 at two different operator control units (HMIs) without any safety concerns.

FIG. 8 shows a container treatment system 1A in accordance with a second exemplary embodiment. The container treatment system 1A in accordance with the second exemplary embodiment is constructed identically to the container treatment system 1 in accordance with the first exemplary embodiment, except for the differences described below. Therefore, substantially only the differences from the first exemplary embodiment are described below.

The container treatment system 1A has, in addition or as an alternative to the depalletizing device 20 for containers 2, such as cans or glass containers, a heating device 14 for heating preforms 2A (preforms) and a forming device 15. The preforms 2A are made of plastic and are formed into containers 2, particularly bottles, in the forming device 15. The containers 2 are subsequently fed to the rinsing device 30. For example, the forming device 15 blows or introduces gas into the heated preforms 2A to form the containers 2. Alternatively, the forming device 15 forms the preforms 2A by introducing a liquid into the containers 2.

The devices 10, 20, 30, 40, 50 handle the containers 2 as previously described with respect to FIG. 1. The transport device 60 also has a flexibly adjustable buffer storage 66. The buffer storage 66 is provided in place of the pasteurizer 70. Thus, no pasteurizations can be carried out with the container treatment system 1A. With the buffer storage 66, the buffer 65 can be dispensed with. In addition, the packaging device 110 is configured to pack the containers 2 into a packaging unit 3 formed from cardboard as the packaging material 112.

Therefore, a case packing station 117 is provided rather than a shrink tunnel 115. The packaging device 110 packages the containers 2 into cartons containing, for example, two or more containers 2 to form the predetermined packaging unit 3. Alternatively, a holder, particularly made of cardboard or other suitable material, can be used in which at least two containers 2 can be inserted to form the predetermined packaging unit 3.

The buffer storage 66 can be used as required to buffer or temporarily store container 2. The containers 2 can then be directed back out of the buffer storage 66 as needed. For this purpose, the at least one detection apparatus 4, 5 detects the operating state of the transport apparatus 60.

The at least one detection apparatus 4, 5 evaluates whether containers 2 are currently to be routed into the buffer storage 66 and/or are to be routed out and/or are to be routed around the buffer storage 66. For this purpose, the at least one detection apparatus 4, 5 evaluates in each case how many containers 2 are to be fed into the buffer storage 66 and/or are to be discharged and/or are to be routed around the buffer storage 66. For the evaluation, the at least one detection apparatus 4, 5 uses detection results of operating states on at least the two devices 50, 80. Additionally, empirical values stored in a memory of the at least one detection apparatus 4, 5 can be used.

Depending on whether the evaluation shows that fewer or more containers 2 are to be fed per unit time to a downstream device, e.g., the device 80 or 100, the buffer storage 66 and, if necessary, additionally the transporters 63 can be used on the outside around the buffer storage 66.

This can extend the time it takes for containers 2 to travel from device 50 to device 80. Additionally or alternatively, the time required for containers 2 to travel from device 50 to device 80 may be reduced, at least temporarily. As a result, the buffer storage 66 can be used to slow down or speed up the speed of the containers 2 as they travel to the device 80.

The arrangement of the apparatuses 4, 5 is otherwise the same as previously described with respect to the apparatuses 4, 5 in accordance with the exemplary embodiment. Furthermore, the principle of operation of the apparatuses 4, 5, 4A, 5A is otherwise the same as previously described with respect to the apparatuses 4, 5, 4A, 5A in accordance with the first exemplary embodiment.

FIG. 9 shows a container treatment system 1B in accordance with a third exemplary embodiment. The container treatment system 1B in accordance with the present exemplary embodiment is constructed identically to the container treatment system 1 in accordance with the first exemplary embodiment, except for the differences described below. Therefore, substantially only the differences from the first exemplary embodiment are described below.

The container treatment system 1B is designed for the production and treating of plastic containers, in particular plastic bottles. The container treatment system 1B has as magazine 10 a preform store for holding preforms 2A (preforms). The preforms 2A are fed to the heating device 14 by a feed rail 13. A mirror 6 is provided on the magazine 10 of FIG. 9 for the detection apparatus 4. The mirror 6 is arranged in such a manner that the detection apparatus 4 can see into the magazine 10. This allows the detection apparatus 4 to detect the operation for feeding the preforms 2A from the magazine 10 to the heating device 14. The acquisition results can be used in the evaluation with the evaluation apparatus, as described previously.

In the system 1, format trolleys 19 are provided for the forming device 15. In addition, format trolleys 49 are provided for the filling device 40. In addition, format trolleys 99 are provided for the equipment device 90. In addition, format trolleys 119 are provided for the packaging device 110. In addition, format trolleys 149 are provided for the palletizing device 140. On the format trolleys 19, 49, 99, 119, 149, formats of the associated devices 15, 40, 90, 110, 140 are provided respectively, which are required for the respective type of containers 2 to be produced in the devices 15, 40, 90, 110, 140. The container treatment system 1B is switchable between, for example, the type of containers 2 for receptacle of 0.5 l of liquid or the type of containers 2 for receptacle of 1.5 l of liquid.

The format trolleys 19, 49, 99, 119, 149 can have a marking in at least one location, particularly at the top, which is interpreted as a format trolley by the at least one detection apparatus 4, 5. This makes the format trolleys particularly easy and quick to detect and evaluate as format trolleys, regardless of their size and appearance.

The at least one detection apparatus 4, 5 is designed to detect where the format trolleys 19, 49, 99, 119, 149 are arranged.

Thus, the at least one detection apparatus 4, 5 can indicate the location of the format trolleys 19, 49, 99, 119, 149 in at least one of the displays 8A in accordance with FIG. 2 to FIG. 7. The associated evaluation apparatus 4A, 5A evaluates the detection result to issue instructions to the mobile robot 7A. An instruction could be that the robot 7A should move to a predetermined format trolley of the format trolleys 19, 49, 99, 119, 149 and perform a predetermined activity there.

The devices 10, 20, 30, 40, 50 handle the containers 2 as previously described with respect to FIG. 1 and/or FIG. 8. Instead of the flexibly adjustable buffer storage 66, the transport device 60 has two flexibly adjustable spiral buffer storage 68. The spiral buffer storage 68 is provided in place of the pasteurizer 70. Thus, no pasteurizations can be carried out with the container treatment system 1B. In addition, the packaging device 110 is configured to pack the containers 2 into a packaging unit 3 that uses adhesive as the packaging material 112. Therefore, instead of a shrink tunnel 115, a curing path 118 is provided in which the adhesive packages are cured with the supply of warm air. The packaging device 110 connects the containers 2 into adhesive packs of, for example, two or more containers 2 to form the predetermined packaging unit 3.

At least one of the spiral buffer storages 68 can be used as needed to buffer or temporarily store containers 2, as previously described with respect to the buffer storage 66 of FIG. 8.

The arrangement of the apparatuses 4, 5 is otherwise the same as previously described with respect to the apparatuses 4, 5 in accordance with the exemplary embodiment. Furthermore, the principle of operation of the apparatuses 4, 5, 4A, 5A is otherwise the same as previously described with respect to the apparatuses 4, 5, 4A, 5A in accordance with the first exemplary embodiment.

In accordance with a modification of the previously described apparatuses 4, 5, at least one of the apparatuses 4, 5 may transmit a radio signal or infrared signal to at least one of the devices 10, 20, 30, 40, 50, 60, 69, 70, 80, 90, 100, 110, 120, 130, 140. The at least one of the devices 10, 20, 30, 40, 50, 60, 69, 70, 80, 90, 100, 110, 120, 130, 140 has a reflector, particularly mirror 6, which transmits the radio signal or infrared signal back to the apparatus 4, 5. Also in this manner, for example, a format trolley 19, 49, 119, 149 or the robot 7A can be detected and recognized.

In a fourth exemplary embodiment, FIG. 10 shows a detail of the equipment device 90. The detection apparatus 5 is arranged above the device 90. The detection apparatus 5 is arranged with the predetermined distance of at least 3 m above the device 90. The detection apparatus 5 can be controlled by the control apparatus 150 of the system 1. The control apparatus 150 may control the orientation of the detection apparatus 5 with respect to the device 90. Additionally or alternatively, the control apparatus 150 may control the type of detection, namely continuous or intermittent, with the detection apparatus 5, as previously explained with respect to the other exemplary embodiments.

The equipment device 90 has a container receiving device 93 that receives the containers 2 as they are treated in the device 90 and moves them past the labeling aggregate 95.

For this purpose, the container receiving device 93 has a frame 930 and turntables 931. The turntables 931 are driven in a movement about their axis by a turntable drive apparatus 932. Each container 2 is receivable between a turntable 931 and a centering head 933. Here, the centering head 933 is moved toward the container 2 or away from the container 2 so that the container 2 can be picked up or released. The centering head 933 centers a container 2 on the turntable 931 such that the axis of the container 2 and the turntable 931 coincide. The container 2 can then be treated with the aggregate 95.

The turntables 931 are spaced apart from one another along the circumference of a carousel 934. Permanent magnets 935 are present on the carousel 934. The magnets 935 are mounted to the carousel 934 facing a first stator 936. The stator 936 has coils that either attract or repel the permanent magnets 935 when appropriately actuated. This can cause the carousel 934 (rotor) to begin or stop movement about the stator 936. The movement is supported by 938 ball swivel connectors. The stator 936 is preferably present only in the area at the periphery of the container receiving device 93, in which aggregates 95 are arranged at the periphery of the container receiving device 93 for handling containers 2.

In addition, the container receiving device 93 has a second stator 937 spaced apart by a gap of permanent magnets 935. The stator 937 has coils that either attract or repel the permanent magnets 935 when controlled appropriately. This allows the centering heads 933 to be set in motion or stopped at their mounting (rotor) around the stator 937. A cam roller 938 adjusts the distance between the centering head 933 and the rotary plates 931. Stator 937 is preferably present along the entire circumference of container receiving device 93.

The unit 95 receives a label roll 951 in a label magazine 91. In addition, a buffer 952, a glue roller 953 and a vacuum cylinder 954 are provided. In addition, a splicing apparatus and a cutting roller may be provided, which are not shown in FIG. 10. When the aggregate 95 is docked at a docking station 94, the aggregate 95 can apply a label from the label roll 951 to container 2.

The aggregate 95 has a line sensor 955 arranged on the label roll 951. The line sensor 955 is configured to detect the end of the label roll 951. The line sensor 955 outputs the detection result 956 as an optical signal to the detection apparatus 5. The detection result 956 is directed by mirrors 6 to the detection apparatus 5. The detection apparatus 5, more specifically its evaluation apparatus 5A, can use the detection result 956 in the evaluation described previously. In particular, the detection result 956 may be visually indicated on the display of FIG. 2 to FIG. 5, as previously described.

In this manner, the detection apparatus 5 can detect the operating states in the device 90. Additionally or alternatively, the detection apparatus 5 uses the detection result 956 from the line sensor 955 to produce, for example, the display of FIG. 2 to FIG. 5.

Additionally or alternatively, the detection apparatus 5 may output a signal to automatically initiate the refill. The detection apparatus 5 sends the change and/or refill signal to the label magazine 91, preferably wirelessly. The signal may be sent to the magazine 91 via the mirrors 6 instead of the detection result 956. For this purpose, the magazine 91 has a receptor that can receive information from an emitter of the detection apparatus 5. The signal may be used to turn on a fault light of the device 90. Alternatively or additionally, the signal may be in the form of Morse code for transmitting information to the device 90, for example, “Trigger flashing to indicate that refilling is about to occur”.

The operating principle of the apparatus 5 is otherwise the same as previously described with respect to the apparatuses 4, 5 in accordance with the first exemplary embodiment.

In a fifth exemplary embodiment, FIG. 11 shows a similar detail of the equipment device 90 as in the preceding exemplary embodiment. Unlike the preceding exemplary embodiment, the device 90 has two aggregates 95.

The detection apparatus 5 and two mirrors 6 are arranged above the device 90. The mirrors 6 are each aligned to direct the detection result of a sensor 957 of the respective aggregate 95 to the detection apparatus 5. The sensory systems of the aggregates 95 do not have to be the same. Optionally, at least one aggregate 95 has a line sensor 955 as described with respect to the preceding exemplary embodiment.

The sensory system 957 is configured as an infrared source or laser diode that senses the end of the label roll 951. The sensor 957 is mounted such that the end of the label roll 951 is detected when light from the sensor 957 reaches the mirror 6 and thus the detection apparatus 5. A photodiode is mounted in the detection apparatus 5 for this purpose.

Alternatively, an infrared source or laser diode is mounted in the detection apparatus 5 and the sensor has a photodiode.

In both embodiments, the sensor 957 with the detection apparatus 5 and the mirrors 6 acts as a light barrier. The light barrier is a one-way light barrier.

Also in this manner, the detection apparatus 5 can detect operating states in the device 90. Additionally or alternatively, the detection apparatus 5 uses the detection result 956 to produce, for example, the display of FIG. 2 to FIG. 5.

Additionally or alternatively, the detection apparatus 5 may output a signal to automatically initiate the refill. The detection apparatus 5 sends the refill signal to the label magazine 91, preferably wirelessly. The signal may be sent to the magazine 91 via the mirrors 6 instead of the detection result 956, as described with reference to the preceding exemplary embodiment.

The principle of operation of the apparatus 5 and the sensory system 957 is otherwise the same as previously described with respect to the preceding exemplary embodiment.

FIG. 12 shows a detail of the devices 110, 120 in a sixth exemplary embodiment. The detection apparatus 5 is arranged above the devices 110, 120. The detection apparatus 5 is arranged with the predetermined distance of at least 3 m above the devices 110, 120. The detection apparatus 5 can be controlled by the control apparatus 150 of the system 1.

The control apparatus 150 may control the orientation of the detection apparatus 5 with respect to the devices 110, 120. Additionally or alternatively, the control apparatus 150 may control the type of detection, namely continuous or intermittent, with the detection apparatus 5, as previously explained with respect to the other exemplary embodiments.

In addition to the magazine 111, which holds rolls of foil 112, and the shrink tunnel 115, the packaging device 110 has a cutting unit 113 and a foil wrapping module 114. The cutting unit 113 cuts the foil 112 from the roll into predetermined parts, such that the foil 112 can each be wrapped around in groups of at least two containers 2.

A handle can be mounted or adhered to the foil container bundle using the device 120. The foil 112 for the handle is ready in a corresponding magazine 121. The magazine 121 is arranged adjacent to the packaging device 110.

After transport into the shrink tunnel 115 and shrinking of the foil 112 onto the containers 2, the packaging unit 3 is formed, which is also referred to as a pack. The packaging unit 3 is transported further with the transporters 63 in the transport direction TR, as described before.

The mirrors 6 are directed towards the magazines 111, 121 in such a manner that the detection apparatus 5 can look into the magazines 111, 121. This allows the detection apparatus 5 to optically detect how much foil 112 is left on the rolls in the magazines 111, 121.

In this manner, the detection apparatus 5 can detect operating states in the devices 110, 120. Additionally or alternatively, the detection apparatus 5 uses at least one of the detection results 116, 126 to produce, for example, the display of FIG. 2 to FIG. 5.

Additionally, the detection apparatus 5 may output a signal to at least one of the robots 135, 136, 7A to initiate a change of rolls of foils.

Here, for example, the detection apparatus 5 outputs the change signal to the robot of robots 135, 136, 7A that is not currently in use and needs to travel the shortest possible path for the change compared to the other robots 135, 136, 7A. The detection apparatus 5 preferably sends the signal wirelessly to the at least one robot 135, 136, 7A. This makes it possible to control things via lasers instead of cables. For this purpose, the robots 135, 136, 7A have a receptor that can receive information from an emitter of the detection apparatus 5.

Additionally or alternatively, it is possible that at least one robot 135, 136, 7A is configured to verify again by optical inspection whether the roll with the foil is really to be changed or not. The at least one robot 135, 136, 7A thus performs an inspection of the detection apparatus 5.

The rolls of foil 112 can be transported by a format trolley 119 and refilled into one of the magazines 111, 121 by robots 135, 136 or robot 7A.

In addition to monitoring the fill level of the magazines 111, 121, the detection apparatus 5 can detect movements of the containers 2. The detection occurs particularly when pushing in to the lanes at the packaging device 110. The detection apparatus 5 passes the detection results to a database used by artificial intelligence in the evaluation apparatus 5A. The database thus stores capture results that were captured at different times in system 1 or in another system. The database is in particular an apparatus for storing the acquisition results and/or at least one indication 8B, 8C, as previously described, for use in the future operation of the container treatment system 1.

The artificial intelligence can search the database for the transport situations where there is a congestion or no congestion at the entrance to the packaging device 110. In addition, artificial intelligence searches for vibration results of a vibrator. By matching the results, the artificial intelligence can figure out how to move or just not move the vibrator to optimally feed the containers 2 into the lanes without jamming.

The artificial intelligence can teach the vibrator accordingly. The vibrator could randomly perform different vibrations for teaching the vibrations to be performed. The shaker can then run the optimal program found during normal operation of system 1. In this case, the invention may also be a stand-alone invention in which the state is detected by only one device.

The operating principle of the apparatus 5 is otherwise the same as previously described with respect to the apparatuses 4, 5 in accordance with the first exemplary embodiment.

Overall, the detection apparatuses 4, 5 of all exemplary embodiments and modifications thereof provide very helpful information that greatly improves the operation of the system 1 and its devices 10, 20, 30, 40, 50, 60, 69, 70, 80, 90, 100, 110, 120, 130, 140 and enables the systems 1, 1A, 1B to operate in a manner that is less prone to failure.

Quite generally, the detection apparatuses 4, 5 are arranged and configured to detect and evaluate various filling states of several individual devices 10, 20, 30, 40, 50, 60, 69, 70, 80, 90, 110, 120, 130, 140 of the system 1, namely preform store, preform hopper, feed rail 13 to forming machine 15, containers 2 on transporters 63, in buffers 65, 66, 68, containers 2 in transport tracks upstream of the packaging device 110, packs upstream of the grouping system, packs upstream of the palletizing device 140, cartons in magazine 111 of the packaging device 110, shrink foil rolls upstream of the packaging device 110, unwinding radius of shrink foil from inserted roll, label magazines 91, closure magazines 51 and/or closure feeders.

Based on such a detection, the next refill task can be evaluated, in particular calculated, as described before. Following this, an output of indications 8B, 8C can be given to operators 7 or automatic refilling systems as to which materials are to be refilled next.

All of the previously described embodiments of the container treatment system 1, 1A, 1B of the devices 4, 4A, 5, 5A, the apparatuses 10, 14, 15, 20, 30, 40, 50, 60, 69, 70, 80, 90, 100, 110, 120, 130, 140 and the method may be used individually or in all possible combinations. In particular, features may also be omitted as long as they are not described as essential to the invention. In addition, the features of all the described exemplary embodiments can be combined as desired. In addition, the following modifications are particularly conceivable.

The parts shown in the figures are schematic diagrams and may differ in exact design from the shapes shown in the figures as long as their previously described functions are guaranteed.

The apparatuses 4, 4A, 5, 5A and, if necessary, mirrors 6 are mountable as a retrofit kit in a container treatment system 1, 1A, 1B.

The transport plane of the transport device 60 does not have to be arranged horizontally. The transport plane can therefore instead be arranged inclined to the horizontal.

It is possible that an optional mechanical jam switch, which is not absolutely necessary, may be used and attached to the transporters 63 and or the buffer storages 66, 68. Here, during operation of the transport device 60, a trip of the jam switch may be used as a 100% occupancy level. This allows for (additional) detection whenever there is a congestion situation on the transport device 60 where one of the transporters 63 is completely occupied with containers 2 or packaging units 3.

### LIST OF REFERENCE NUMBERS

1, 1A, 1B device
2 containers
1A preform (container)
3 packaging unit
3A location
4, 5 detection apparatus, camera
6 mirror
7 operator
8 display apparatus
8A display
8B, 8C indication
2A mouth
10 magazine
12 pallet
13 feed rail
14 heating device, oven
15 forming device, stretch blow molding machine
19 format trolley
20 depalletizing device
30 rinsing device or transporters
31 tank
32 rinsing liquid
40 filling device
41 tank
42 product to be filled
45 filling aggregate or rinser
46 filling aggregate
49 format trolley
50 closing device
51 magazine
52 container closure
54 transport starwheel (inlet)
55 stretch blow molding machine carousel
56 transport starwheel (outlet)
57 enclosure
60 transport device
61 tank
62 lubricants
63 transporter
64 diverter
65 buffer
66 buffer storage
67 enclosure
68 spiral buffer storage
69 inspection device
70 pasteur
80 drying device
90 equipment device
91 tank
92 glue
95, 96 equipment aggregate
97 label
98 pressure
99 format trolley
100 distribution device
110 packaging device
111 magazine or tank for glue
112 packaging material, foil
113 cutting unit
114 foil wrapping module
115 shrink tunnel
116 detection result
117 carton packing station
118 curing path
119 format trolley
120 handle assembly device
121 magazine
122 handle
126 detection result
130 sorting device
133 guide apparatus
135, 136 robots
140 palletizing device
142 pallet
149 format trolley
150 control apparatus
160 external apparatus
631, 632 deflection roller
633 chain, conveyor belt
930 frame
931 turntable
932 turntable drive apparatus
933 centering head
934 carousel
935 permanent magnet
936 first stator
937 second stator
938 ball swivel connector
939 cam roller
951 label roll
952 buffer
953 glue roller
954 vacuum cylinder
955 line sensor
956 detection result
957 sensor
TD, TD1, TD2 optical identification
TR transport direction

1. A container treatment system for treating containers, having at least two container treatment devices for treating a container by at least one of the following types of treatment, namely transporting, buffering, sorting, grouping, inspecting, heating, forming, equipping, coating, sterilizing, filling, sealing, cleaning, grouping, distributing, unpacking, sorting, de-labeling, drying, gluing, unscrewing, packaging, palletizing, depalletizing,
a detection apparatus for detecting at least one operating state of the at least two container treatment devices, and
an evaluation apparatus configured to evaluate the detection result of the detection apparatus with respect to the type of operating state detected.

2. The container treatment system according to claim 1, wherein the evaluation apparatus is configured to evaluate which at least one activity is to be performed on at least one of the at least two container treatment devices as a result of the at least one operating state detected by the detection apparatus.

3. The container treatment system according to claim 1, wherein the evaluation apparatus is configured to determine at least one indication of the at least one activity to be performed on the at least one container treatment device on the basis of the detected operating state and to output it to an operator and/or a refilling aggregate of the at least one container treatment device and/or to an apparatus for storing the at least one indication for use in the future operation of the container treatment system.

4. The container treatment system according to claim 1,
wherein the evaluation apparatus is configured to evaluate which at least one activity is to be performed on at least one of the at least two container treatment devices as a result of the at least one operating state detected by the detection apparatus, and
wherein the evaluation apparatus is configured to evaluate which shortest path an operator has to cover to perform the evaluated at least one activity, and
wherein the evaluation apparatus is configured to output the evaluated shortest path for the operator.

5. The container treatment system according to claim 4, wherein the evaluation apparatus is configured to determine the shortest path with respect to the container treatment system and/or the entire premises of an operation in which the container treatment system is mounted.

6. The container treatment system according to claim 1, wherein the evaluation apparatus is configured to evaluate which material is to be reordered as a consequence of the at least one operating state detected by the detection apparatus at at least one of the at least two container treatment devices.

7. The container treatment system according to claim 6, wherein the evaluation apparatus is configured to output information about the material to be reordered to a display apparatus for display.

8. The container treatment system according to claim 1, wherein the type of operating state detected comprises the type of a fault occurring in the container treatment device.

9. The container treatment system according to claim 8,
wherein the nature of a fault comprises whether the fault endangers the safety of an operator of the at least one container treatment device and/or how quickly the fault is to be rectified to ensure the safety of the at least one container treatment device or of the operator of the at least one container treatment device, and
wherein the evaluation apparatus is designed to evaluate in which sequence activities are to be carried out or blocked as a consequence of the at least one operating state detected by the detection apparatus on at least one of the at least two container treatment devices.

10. The container treatment system according to claim 1,
wherein the detection apparatus has at least one camera arranged at a distance of at least 3 m above the container treatment system, and/or
wherein the detection apparatus has the evaluation apparatus, and/or
wherein the container treatment system has a control apparatus (150) which is designed to control the at least one container treatment device and which has at least a part of the evaluation apparatus.

11. The container treatment system according to claim 1,
wherein the detection apparatus has at least one mirror arranged for directing an optical signal of the container treatment system to the detection apparatus, and/or
wherein the evaluation apparatus is configured to use, for the evaluation of the detection result of the at least one detection apparatus, data of an apparatus which stores at least one indication which was determined and output in the preceding operation of the container treatment system, and/or
wherein the container treatment system is configured to receive at least one indication from an external apparatus that at least one activity is to be performed on at least one of the at least two container treatment devices.

12. A container treatment method for treating containers, wherein the method is carried out with a container treatment system having at least two container treatment devices, a detection apparatus and an evaluation apparatus, and wherein the method has the steps of
detecting, with the detection apparatus, at least one operating state of the at least two container treatment devices,
treating, with the at least two container treatment devices, a container by at least one of the following types of treatment, namely transporting, buffering, sorting, grouping, inspecting, heating, forming, shaping, equipping, coating, sterilizing, filling, sealing, cleaning, grouping, distributing, unpacking, sorting, de-labeling, unscrewing, drying, sticking, packaging, palletizing, depalletizing, and
evaluating, with the evaluation apparatus, the detection result of the at least one detection apparatus to determine the type of operating state detected.

13. The method according to claim 12, wherein the treating step is performed at least partially before the detecting step.

14. The method according to claim 12, wherein the detecting step and the treating step are performed simultaneously at least at times.

15. The method according to any of claim 12, wherein the detecting step is performed intermittently with predetermined temporal distances or continuously.

16. A container treatment system having at least two container treatment systems, each having at least one container treatment device for treating containers by at least one of the following types of treatment, namely transporting, buffering, sorting, distributing, unpacking, de-labeling, unscrewing, drying, grouping, inspecting, heating, forming, equipping, coating, sterilizing, filling, closing, cleaning, packaging, palletizing, depalletizing, further having a detection apparatus for detecting at least one operating state of in each case at least one container treatment device of the at least two container treatment systems, and an evaluation apparatus which is designed to evaluate the detection result of the detection apparatus with respect to the type of operating state detected.
